(19) United States
(12) Patent Application Publication
(10) Pub. No.: US 2023/0193436 A1
(43) Pub. Date: Jun. 22, 2023

(54) STAINLESS STEEL POWDER COMPOSITION, PREPARING METHOD THEREOF AND METHOD OF PREPARING STAINLESS STEEL WORKPIECE BY LASER ADDITIVE MANUFACTURING

(71) Applicant: Chung Yo Materials Co., Ltd., Kaohsiung City (TW)

(72) Inventors: CHIEN-HUNG YEH, Kaohsiung City (TW); CHENG-CHIN WANG, Kaohsiung City (TW); CHANG-FU WANG, Kaohsiung City (TW); YI-JEN LAI, Kaohsiung City (TW); HONG-YI CHEN, Kaohsiung City (TW)

(21) Appl. No.: 18/084,126

(22) Filed: Dec. 19, 2022

Related U.S. Application Data
(60) Provisional application No. 63/291,840, filed on Dec. 20, 2021.

(51) Int. Cl. C22C 33/02; C22C 33/04; C22C 38/42; C22C 38/44; C22C 38/04; C22C 38/00; B22F 10/28

(52) U.S. Cl. CPC C22C 33/0285; B22F 10/28; C22C 33/04; C22C 38/002; C22C 38/04; C22C 38/42; C22C 38/44; B22F 2203/13; B22F 2301/35; B22F 2998/10; B22F 2999/00; B33Y 10/00

(57) ABSTRACT

Provided is a stainless steel powder composition, which comprises Cr, Cu, Mn, Mo, Ni and Fe; wherein, based on a total weight of the stainless steel powder composition, a content of Cr is 20 wt% to 24 wt%, and a content of Cu is more than 0 wt% and less than or equal to 0.5 wt%, a content of Mn is more than 0 wt% and less than or equal to 2 wt%, a content of Mo is 2.25 wt% to 3 wt% and a content of Ni is 10 wt% to 15 wt%. When applying the stainless steel powder composition of the present invention to laser additive manufacturing (LAM), the produced stainless steel workpiece has enhanced tensile strength, thereby expanding the follow-up applications and increasing the commercial value.

### CROSS-REFERENCE TO RELATED APPLICATION

Pursuant to 35 U.S.C. § 119(a), this application claims the benefits of the priority to U.S. Provisional Pat. Application No. 63/291,840, filed Dec. 20, 2021. The contents of the prior application are incorporated herein by its entirety.

### BACKGROUND OF THE INVENTION

### 1. Field of the Invention

The present invention relates to a powder composition, a preparing method thereof and a method of laser additive manufacturing, particularly to a stainless steel powder composition, a preparing method thereof and a method of preparing a stainless steel workpiece by laser additive manufacturing and utilizing the stainless steel powder composition.

### 2. Description of the Prior Arts

Steel generally refers to iron (Fe) as the main component, and contains other elements such as chromium (Cr), nickel (Ni) or manganese (Mn) for exhibiting different mechanical properties and physical properties. Taking stainless steel for example, stainless steel mostly contains Cr as the main additive element, such that a dense chromium oxide protective layer forms on the surface of the stainless steel, thereby preventing the interior of the stainless steel from contacting water in the atmosphere to reduce corrosion. Accordingly, stainless steel has been widely used in numerous fields such as construction, chemical industry, medical equipment or food equipment.

In the past, stainless steel workpieces are usually produced by melting process. However, it is difficult for the stainless steel workpiece produced by melting to proceed to the subsequent cutting process, such that the workpiece is hardly size-adjustable, and is prone to drawbacks such as rough surfaces. Therefore, at present, stainless steel workpieces are mostly produced by stainless steel powder metallurgy, which includes main processes of placing stainless steel powder into a mold, applying pressure and then sintering to produce stainless steel workpieces, thereby having advantages of high dimensional accuracy, high material utilization rate and uniform structure.

On the other hand, with the development and progress of science and technology, laser additive manufacturing (LAM; also known as 3D printing) has become mature and can be applied to produce metal workpieces, and LAM has advantages of low cost, high efficiency and high degree of freedom. When producing metal workpieces, it is usually carried out by a technique called powder bed fusion (PBF) of LAM. The main principle of PBF is to focus the laser beam on a powder bed covered with metal powders based on the pre-set pattern, such that the metal powders in a specific area are melted and then fused with each other to obtain a single metal deposited layer, and then the foresaid steps are repeated to make each obtained metal deposited layer superimpose on the previously obtained metal deposited layer, so as to construct a complete three-dimensional metal object.

Therefore, stainless steel workpiece also can adopt stainless steel powder as its raw material, and then be produced by LAM. However, the stainless steel workpiece adopting the known stainless steel powder, such as 316L stainless steel powder, as raw material and then produced by LAM generally has poor mechanical properties, such as density and tensile strength. Thus, the stainless steel workpiece adopting the known stainless steel powder as raw material is inappropriate for a stainless steel workpiece with complicated structure, which limits the follow-up applications. Besides, when adopting the known stainless steel powder for conducting LAM, welding slag is easily generated during the process, which reduces the stability of the process and the density of the stainless steel workpiece, thereby affecting the quality of the stainless steel workpiece and also limiting the follow-up applications.

Accordingly, there is still a need to research and develop a stainless steel powder composition, such that the stainless steel workpiece adopting the stainless steel powder composition as raw material and produced by LAM has better tensile strength, thereby improving the applicability and the commercial value.

### SUMMARY OF THE INVENTION

In view of the problems in the prior art, an objective of the present invention is to provide a stainless steel powder composition, and a stainless steel workpiece adopting the stainless steel powder composition of the present invention as raw material and produced by LAM has a tensile strength more than 700 MPa.

To achieve the foresaid objective, the present invention provides a stainless steel powder composition, which comprises Cr, copper (Cu), Mn, molybdenum (Mo), Ni and Fe; wherein, based on a total weight of the stainless steel powder composition, a content of Cr is 20 weight percent (wt%) to 24 wt%, and a content of Cu is more than 0 wt% and less than or equal to 0.5 wt%, a content of Mn is more than 0 wt% and less than or equal to 2 wt%, a content of Mo is 2.25 wt% to 3 wt% and a content of Ni is 10 wt% to 15 wt%.

By controlling the content of each component within a specific range, when applying the stainless steel powder composition of the present invention to LAM for producing a stainless steel workpiece, the laser beam melts each component of the stainless steel powder composition and then makes the melted components fuse to form an alloy, thereby increasing the content of Ferrite (also known as α-Fe) in the alloy. Therefore, the produced stainless steel workpiece has enhanced tensile strength, and thus can expand the follow-up applications.

Preferably, based on the total weight of the stainless steel powder composition, the content of Ni is 11.5 wt% to 13.5 wt%. By further controlling the content of Ni within the specific range, when applying the stainless steel powder composition of the present invention to LAM for producing stainless steel workpiece, the tensile strength of the stainless steel workpiece can be further enhanced.

Preferably, based on the total weight of the stainless steel powder composition, the content of Cr is 22 wt% to 24 wt%.

In some embodiments of the present invention, based on the total weight of the stainless steel powder composition, the content of Cu is more than or equal to 0.1 wt% and less than or equal to 0.5 wt%. Preferably, based on the total weight of the stainless steel powder composition, the content of Cu is 0.1 wt% to 0.35 wt%. More preferably, based on the total weight of the stainless steel powder composition, the content of Cu is 0.2 wt% to 0.35 wt%.

In some embodiments of the present invention, based on the total weight of the stainless steel powder composition, the content of Mn is more than or equal to 0.5 wt% and less than or equal to 2 wt%. Preferably, based on the total weight of the stainless steel powder composition, the content of Mn is 0.5 wt% to 1.5 wt%. More preferably, based on the total weight of the stainless steel powder composition, the content of Mn is 1 wt% to 1.5 wt%.

In some embodiments of the present invention, based on the total weight of the stainless steel powder composition, the content of Mo is 2.25 wt% to 2.6 wt%.

In accordance with the present invention, based on the total weight of the stainless steel powder composition, a content of Fe is 55 wt% to 65 wt%. Preferably, based on the total weight of the stainless steel powder composition, a content of Fe is 58 wt% to 62 wt%.

In accordance with the present invention, the stainless steel powder composition further comprises, but is not limited to, phosphorus (P), sulfur (S), silicon (Si), carbon (C), oxygen (O) or a combination thereof. It should be understood that these elements may originally exist in each metal raw material, or may be derived from the equipment and environment of the preparing process.

Preferably, based on the total weight of the stainless steel powder composition, a content of P contained in the stainless steel powder composition is less than or equal to 0.025 wt%. More preferably, based on the total weight of the stainless steel powder composition, a content of P contained in the stainless steel powder composition is less than or equal to 0.01 wt%. Even more preferably, based on the total weight of the stainless steel powder composition, a content of P contained in the stainless steel powder composition is less than or equal to 0.0085 wt%. By controlling the content of P contained in the stainless steel powder composition within the specific range, the density and quality of the stainless steel workpiece produced by follow-up LAM can be further enhanced.

Preferably, based on the total weight of the stainless steel powder composition, a content of S contained in the stainless steel powder composition is less than or equal to 0.03 wt%. More preferably, based on the total weight of the stainless steel powder composition, a content of S contained in the stainless steel powder composition is less than or equal to 0.003 wt%. Even more preferably, based on the total weight of the stainless steel powder composition, a content of S contained in the stainless steel powder composition is less than or equal to 0.0025 wt%. By controlling the content of S contained in the stainless steel powder composition within the specific range, the density and quality of the stainless steel workpiece produced by follow-up LAM can be further enhanced.

In some embodiments of the present invention, based on the total weight of the stainless steel powder composition, a content of Si contained in the stainless steel powder composition is less than or equal to 0.75 wt%. Preferably, based on the total weight of the stainless steel powder composition, a content of Si contained in the stainless steel powder composition is less than or equal to 0.5 wt%. More preferably, based on the total weight of the stainless steel powder composition, a content of Si contained in the stainless steel powder composition is less than or equal to 0.3 wt%.

In some embodiments of the present invention, based on the total weight of the stainless steel powder composition, a content of C contained in the stainless steel powder composition is less than or equal to 0.03 wt%. Preferably, based on the total weight of the stainless steel powder composition, a content of C contained in the stainless steel powder composition is less than or equal to 0.02 wt%. More preferably, based on the total weight of the stainless steel powder composition, a content of C contained in the stainless steel powder composition is less than or equal to 0.015 wt%.

In some embodiments of the present invention, based on the total weight of the stainless steel powder composition, a content of O contained in the stainless steel powder composition is less than or equal to 0.05 wt%.

Preferably, a stainless steel workpiece adopting the stainless steel powder composition of the present invention as raw material and produced by LAM has a tensile strength of 700 MPa to 800 MPa.

Besides, the present invention also provides a preparing method of a stainless steel powder composition, which comprises the following steps: step (a): mixing a Cr raw material, a Cu raw material, a Mn raw material, a Mo raw material, a Ni raw material and an Fe raw material to obtain a mixture; wherein, based on a total weight of the mixture, a content of the Cr raw material is 20 wt% to 24 wt%, a content of the Cu raw material is more than 0 wt% and less than or equal to 0.5 wt%, a content of the Mn raw material is more than 0 wt% and less than or equal to 2 wt%, a content of the Mo raw material is 2.25 wt% to 3 wt% and a content of the Ni raw material is 10 wt% to 15 wt%; and step (b): melting the mixture and then atomizing with an inert gas to obtain the stainless steel powder composition.

By controlling the contents of each component within a specific range, the stainless steel powder composition prepared by the preparing method of the present invention can be applied to LAM, and then produces a stainless steel workpiece having enhanced tensile strength, which expands the subsequent applications.

Preferably, based on the total weight of the mixture, the content of the Ni raw material is 11.5 wt% to 13.5 wt%. By further controlling the content of the Ni raw material within the specific range to produce the stainless steel powder composition of the present invention, when applying the stainless steel powder composition to LAM for producing a stainless steel workpiece, the tensile strength of the stainless steel workpiece can be further enhanced.

Preferably, based on the total weight of the mixture, the content of the Cr raw material is 22 wt% to 24 wt%.

In some embodiments of the present invention, based on the total weight of the mixture, the content of the Cu raw material is more than or equal to 0.1 wt% and less than or equal to 0.5 wt%. Preferably, based on the total weight of the mixture, the content of the Cu raw material is 0.1 wt% to 0.35 wt%. More preferably, based on the total weight of the mixture, the content of the Cu raw material is 0.2 wt% to 0.35 wt%.

In some embodiments of the present invention, based on the total weight of the mixture, the content of the Mn raw material is more than or equal to 0.5 wt% and less than or equal to 2 wt%. Preferably, based on the total weight of the mixture, the content of the Mn raw material is 0.5 wt% to 1.5 wt%. More preferably, based on the total weight of the mixture, the content of the Mn raw material is 1 wt% to 1.5 wt%.

In some embodiments of the present invention, based on the total weight of the mixture, the content of the Mo raw material is 2.25 wt% to 2.6 wt%.

In accordance with the present invention, based on the total weight of the mixture, a content of the Fe raw material is 55 wt% to 65 wt%. Preferably, based on the total weight of the mixture, a content of the Fe raw material is 58 wt% to 62 wt%.

Preferably, the purities of the Cr raw material, the Cu raw material, the Mn raw material, the Mo raw material, the Ni raw material and the Fe raw material are more than 99.5%. More preferably, the purities of the Cr raw material, the Cu raw material, the Mn raw material, the Mo raw material, the Ni raw material and the Fe raw material are more than 99.5% and less than or equal to 99.99%. By controlling the purity of each metal raw material within a specific range, contents of impurities contained in the prepared stainless steel powder composition can be further reduced, thereby further enhancing the density and quality of the stainless steel workpiece produced by follow-up LAM.

Preferably, in the step (b), an environmental pressure during the atomizing is 2.5×10⁻³ torr to 3.5×10⁻³ torr. More preferably, in the step (b), an environmental pressure during the atomizing is 3×10⁻³ torr.

Preferably, in the step (b), during the atomizing, an ejection pressure of the inert gas is 20 bar to 30 bar. More preferably, in the step (b), during the atomizing, an ejection pressure of the inert gas is 25 bar.

Preferably, in the step (b), the inert gas comprises argon (Ar), nitrogen (N₂) or a combination thereof. More preferably, in the step (b), the inert gas comprises Ar.

Preferably, in the step (b), a temperature of melting the mixture is 1650° C. to 1750° C. More preferably, in the step (b), a temperature of melting the mixture is 1700° C.

In accordance with the present invention, the step of melting the mixture and then atomizing with an inert gas in the step (b) may adopt vacuum induction melting inert gas atomization to obtain the stainless steel powder composition. Specifically, all components of the mixture are melted, and then atomized with high pressure inert gas. After cooling, a spherical powder with high roundness and micron size (usually 1 micrometer (µm) to 300 µm, such as 15 µm to 53 µm) is obtained, and thus the stainless steel powder composition of the present invention is obtained.

Besides, the present invention also provides a method of preparing a stainless steel workpiece, which comprises adopting the stainless steel powder composition of the present invention and preparing the stainless steel workpiece from the stainless steel powder composition by LAM. When applying the stainless steel powder composition of the present invention to LAM, the produced stainless steel workpiece has enhanced tensile strength. Specifically, said LAM may be PBF.

Preferably, the stainless steel workpiece may be, but is not limited to, a shoe mold, a fixture, accessories or a water-cooled module. Preferably, the stainless steel workpiece may be a shoe mold.

In the specification, a range represented by “a lower-endpoint value to an upper-endpoint value”, if not particularly specified, indicates that the range encompasses more than or equal to the lower-endpoint value and less than or equal to the upper-endpoint value. For example, “a content of Cr is 20 wt% to 24 wt%” indicates that a content of Cr is “more than or equal to 20 wt% and less than or equal to 24 wt%”.

Other objectives, advantages and novel features of the instant disclosure will become more apparent from the following detailed description.

### DETAILED DESCRIPTION OF THE PREFERRED EMBODIMENTS

Hereinafter, preparation methods of several embodiments are exemplified to illustrate the implementation of the present invention. One person skilled in the art can easily realize the advantages and effects of the present invention in accordance with the contents of the specification. Various modifications and variations could be made in order to practice or apply the present invention without departing from the spirit and scope of the invention.

### Examples 1 to 3: Stainless Steel Powder Composition

According to the compositions and the contents listed in the following Table 1, Cr powder, Cu powder, Mn powder, Mo powder, Ni powder and Fe powder in suitable amounts were mixed to obtain a mixture; wherein, the purity of the Cr powder was 99.6%, the purity of the Cu powder was 99.81%, the purity of the Mn powder was 99.8%, the purity of the Mo powder was 99.8%, the purity of the Ni powder was 99.8% and the purity of the Fe powder was 99.7%.

Next, the mixture was placed at an environment with a temperature of 1700° C. and pressure of 3 10 x⁻³ torr, and then atomized with argon under gas ejection pressure of 25 bar to obtain the stainless steel powder compositions of Examples 1 to 3. In the following Table 1, the contents of Cr, Cu, Fe, Mn, Mo, Ni, P and Si of the stainless steel powder compositions of Examples 1 to 3 were measured and obtained by inductively coupled plasma optical emission spectrometer (ICP-OES; manufacturer: Agilent; model: 5110 ICP-OES); the contents of C and S thereof were measured and obtained by carbon/sulfur analyzer (manufacturer: HORIBA; model: EMIA 20P); and the content of O was measured and obtained by oxygen/nitrogen/hydrogen analyzer (manufacturer: HORIBA; model: EMGA 830).

### Comparative Example 1: Stainless Steel Powder Composition

The preparing processes of Comparative Example 1 were similar to Examples 1 to 3, and the main difference was that Comparative Example 1 adopted different contents of components to prepare the mixture according to the following Table 1. Also, in Comparative Example 1, the purity of the Cr powder was 98.5%, the purity of the Cu powder was 99%, the purity of the Mn powder was 99%, the purity of the Mo powder was 98.5%, the purity of the Ni powder was 99% and the purity of the Fe powder was 99%. Except for the foresaid differences, the rest of the preparing processes were the same as Examples 1 to 3, so as to obtain the stainless steel powder composition of Comparative Example 1. In the following Table 1, the content of each component of the stainless steel powder composition of Comparative Example 1 was measured and obtained by the same ways as Examples 1 to 3.

TABLE 1

The compositions and contents of the stainless steel powder compositions of Examples 1 to 3 and Comparative Example 1.

| Compositions | Comparative Example 1 | Example 1 | Example 2 | Example 3 |
|---|---|---|---|---|
| | Content of each component (wt%) | | | |
| Cr | 18.18 | 22.58 | 22.03 | 22.34 |
| Cu | 0.095 | 0.250 | 0.226 | 0.280 |
| Fe | Balance | Balance | Balance | Balance |
| Mn | 1.073 | 1.102 | 1.094 | 1.123 |
| Mo | 2.631 | 2.465 | 2.473 | 2.599 |
| Ni | 14.08 | 12.80 | 14.01 | 14.70 |
| P | 0.013 | 0.008 | 0.007 | 0.008 |
| Si | 0.346 | 0.272 | 0.291 | 0.257 |
| C | 0.022 | 0.007 | 0.012 | 0.011 |
| S | 0.004 | 0.001 | 0.002 | 0.002 |
| O | More than 0.05 | Less than 0.05 | Less than 0.05 | Less than 0.05 |

### Test Example 1: Evaluation of Tensile Strength

The stainless steel compositions of Examples 1 to 3 and Comparative Example 1 were adopted, and the tensile strength test was carried out according to the specifications of ASTM E8/E8M-16a test method. Specifically, the stainless steel powder compositions of Examples 1 to 3 and Comparative Example 1 were subjected to PBF to produce the same size of stainless steel samples of Examples 1 to 3 and Comparative Example 1. Then, the stainless steel samples of Examples 1 to 3 and Comparative Example 1 were each placed onto an universal testing machine (manufacturer: SHIMADZU; model: UH-F300KNXR) for the tensile strength test, and the results of tensile strength of Examples 1 to 3 and Comparative Example 1 were listed in the following Table 2.

TABLE 2

The results of tensile strength of Examples 1 to 3 and Comparative Example 1.

| Groups | Tensile strength (MPa) |
|---|---|
| Example 1 | 735 |
| Example 2 | 739 |
| Example 3 | 792 |
| Comparative Example 1 | 654 |

According to the results in the above Table 2, the tensile strength of Comparative Example 1 was only 654 MPa, while the tensile strength of Examples 1 to 3 were all higher than 700 MPa. Specifically, compared to Comparative Example 1, the tensile strength of Example 1 had increased by about 12%; the tensile strength of Example 2 had increased by about 13%; and the tensile strength of Example 3 had increased up to about 21%. Accordingly, Examples 1 to 3 had obviously higher tensile strength than Comparative Example 1. That is, by adopting the stainless steel powder composition of the present invention as raw material and then producing a stainless steel workpiece by LAM, the produced stainless steel workpiece actually had enhanced tensile strength.

In summary, as the present invention controls the content of each component of the stainless steel powder composition within a specific range, and then applying the stainless steel powder composition of the present invention to LAM, the produced stainless steel workpiece has enhanced tensile strength, thereby expanding the follow-up applications and increasing the commercial value.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A stainless steel powder composition, comprising chromium, copper, manganese, molybdenum, nickel and iron; wherein, based on a total weight of the stainless steel powder composition, a content of chromium is 20 weight percent to 24 weight percent, a content of copper is more than 0 weight percent and less than or equal to 0.5 weight percent, a content of manganese is more than 0 weight percent and less than or equal to 2 weight percent, a content of molybdenum is 2.25 weight percent to 3 weight percent and a content of nickel is 10 weight percent to 15 weight percent.

2. The stainless steel powder composition as claimed in claim 1, wherein based on the total weight of the stainless steel powder composition, the content of nickel is 11.5 weight percent to 13.5 weight percent.

3. The stainless steel powder composition as claimed in claim 1, wherein based on the total weight of the stainless steel powder composition, the content of chromium is 22 weight percent to 24 weight percent.

4. The stainless steel powder composition as claimed in claim 1, wherein based on the total weight of the stainless steel powder composition, a content of phosphorus contained in the stainless steel powder composition is less than or equal to 0.025 weight percent and a content of sulfur contained in the stainless steel powder composition is less than or equal to 0.03 weight percent.

5. The stainless steel powder composition as claimed in claim 2, wherein based on the total weight of the stainless steel powder composition, a content of phosphorus contained in the stainless steel powder composition is less than or equal to 0.025 weight percent and a content of sulfur contained in the stainless steel powder composition is less than or equal to 0.03 weight percent.

6. The stainless steel powder composition as claimed in claim 3, wherein based on the total weight of the stainless steel powder composition, a content of phosphorus contained in the stainless steel powder composition is less than or equal to 0.025 weight percent and a content of sulfur contained in the stainless steel powder composition is less than or equal to 0.03 weight percent.

7. A preparing method of a stainless steel powder composition, comprising the following steps:
step (a): mixing a chromium raw material, a copper raw material, a manganese raw material, a molybdenum raw material, a nickel raw material and an iron raw material to obtain a mixture; wherein, based on a total weight of the mixture, a content of the chromium raw material is 20 weight percent to 24 weight percent, a content of the copper raw material is more than 0 weight percent and less than or equal to 0.5 weight percent, a content of the manganese raw material is more than 0 weight percent and less than or equal to 2 weight percent, a content of the molybdenum raw material is 2.25 weight percent to 3 weight percent and a content of the nickel raw material is 10 weight percent to 15 weight percent; and
step (b): melting the mixture and then atomizing with an inert gas to obtain the stainless steel powder composition.

8. The preparing method as claimed in claim 7, wherein based on the total weight of the mixture, the content of the nickel raw material is 11.5 weight percent to 13.5 weight percent.

9. The preparing method as claimed in claim 7, wherein based on the total weight of the mixture, the content of the chromium raw material is 22 weight percent to 24 weight percent.

10. The preparing method as claimed in claim 7, wherein the purities of the chromium raw material, the copper raw material, the manganese raw material, the molybdenum raw material, the nickel raw material and the iron raw material are more than 99.5%.

11. The preparing method as claimed in claim 7, wherein in the step (b), an environmental pressure during the atomizing is 2.5×10⁻³ torr to 3.5×10⁻³ torr.

12. The preparing method as claimed in claim 8, wherein in the step (b), an environmental pressure during the atomizing is 2.5×10⁻³ torr to 3.5×10⁻³ torr.

13. The preparing method as claimed in claim 9, wherein in the step (b), an environmental pressure during the atomizing is 2.5×10⁻³ torr to 3.5×10⁻³ torr.

14. The preparing method as claimed in claim 10, wherein in the step (b), an environmental pressure during the atomizing is 2.5×10⁻³ torr to 3.5×10⁻³ torr.

15. A method of preparing a stainless steel workpiece, comprising adopting the stainless steel powder composition as claimed in claim 1 and preparing the stainless steel workpiece from the stainless steel powder composition by laser additive manufacturing.
